(19) United States
(12) Patent Application Publication
(10) Pub. No.: US 2009/0245029 A1
(43) Pub. Date: Oct. 1, 2009

(54) ACTIVITY REMINDER SMART CARD

(76) Inventor: Kin Fai Kam, York (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/597,400

(22) PCT Filed: Jan. 21, 2005
(86) PCT No.: PCT/GB2005/000212

§ 371 Date: Jul. 24, 2006

(30) Foreign Application Priority Data
Jan. 24, 2004 (GB) 0401575.6
Apr. 29, 2004 (GB) 0409531.1
Sep. 14, 2004 (GB) 0420397.2

(51) Int. Cl. G06K 19/07; G04B 47/00

(52) U.S. Cl. 368/10; 235/492

(57) ABSTRACT

A method and apparatus for reminding a user when an activity is to be performed is disclosed. The apparatus includes a smartcard (10) comprising a card body (11), and integrated circuit microprocessor (12) and a power source (13). In addition at least one user alert device (14) such as an alarm or flashing tight is included to alert a user at a predetermined time prior to performance of the activity.

The present invention relates to apparatus and a method for reminding a user of an activity to be performed. In particular, but not exclusively, the present invention relates to a smart card including a visual and/or audible alarm which conforms to a smart card technology standard. The smart card can be used as a convenient prompt for a variety of uses such as issuing a reminder when appointments are due.

It is well known that the inefficiency and cost associated with missing appointments is an important concern to many service providers that allocate scheduled appointments to their clients. One such service provider would be medical practitioners although embodiments of the present invention are not restricted to such uses. Increasingly some service providers are utilising electronic means such as emails, mobile phone text messages and direct telephone calls to remind a client of an imminent appointment. All of these methods have some significant cost implications. Also there may be practical problems since not everyone has a personal computer to receive email or a mobile telephone to receive text messages or indeed a telephone to receive direct calls.

It is an aim of the present invention to at least partly mitigate the above-mentioned problems.

It is an aim of embodiments of the present invention to provide a portable smart card alarm conforming to a well known standard for smart card technology.

It is an aim of embodiments of the present invention to provide a method for reminding a user to perform a predetermined activity so that activity is carried out in due course.

According to a first aspect of the present invention there is provided an apparatus for reminding a user of an activity to be performed, comprising:
a Smart Card comprising:
a card body;
an integrated circuit microprocessor;
a power source; and
at least one user alert device for alerting a user at a predetermined time prior to performance of said activity.

According to a second aspect of the present invention there is provided a method for reminding a user to perform a predetermined activity, comprising the steps of:
providing a Smart Card comprising at least one user alert device for providing an alert cue to a user at a predetermined time prior to performance of said activity;
programming said Smart Card via a Smart Card reader;
providing said programmed Smart Card to said user; and
at said predetermined time generating an alert cue via said Smart Card.

Embodiments of the present invention provide a smart card which is programmable repeatably with a commonly available PC/smart card compliant smart reader. This reusability means that costs for providing smart cards are kept at a minimum. Also the familiarity and relevance to existing smart card applications means that users will readily accept that embodiments of the present invention may be adopted to their business. Embodiments of the present invention also provide a multifunction smart card which enables the smart card to act as an existing passive smart card but also as a smart card alarm.

Embodiments of the present invention provide a number of further advantages over previous reminder systems. Notably embodiments of the present invention can provide:
a very thin and compact, portable device with a time clock to trigger one or more events (e.g. alarm alerts) according to pre-programmed data and instructions;
means for setting the time clock and the event times from a remote terminal, and if necessary means to alter other data or programs in the smart card device;
means for creating an audible sound, vibration and/or electromagnetic radiation as forms of a reminder alert which acts as a cue to prompt a user into action;
means to control functions e.g. to turn off alarm;
a compact power source; and
the ability to display and alter information held in the said device.

Embodiments of the present invention provide the advantage that unlike known authentication cards which are often produced on a small scale, embodiments of the present invention have the potential to become a mass-market device due to the fact that familiar and common technology is used. As more smart cards are produced the cost of individual non-personalised cards will become extremely affordable. Embodiments of the present invention may have printed subject matter such as adverts printed on them. This can further reduce costs.

Embodiments of the present invention can be used as promotional material and may be designed as a business card. This has the ability to remind clients of important events or of services provided prior to an event.

Embodiments of the present invention will now be described hereinafter, by way of example only, with reference to the accompanying drawings in which:

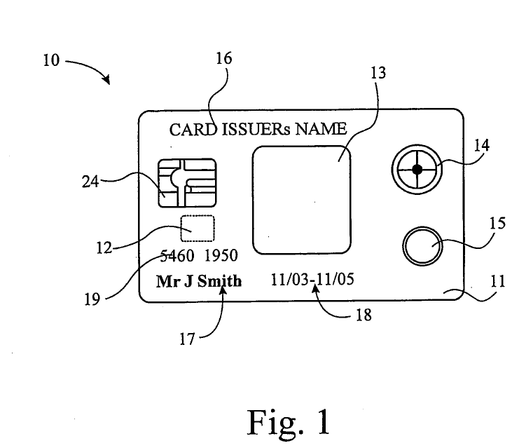

FIG. 1 illustrates a smart card;

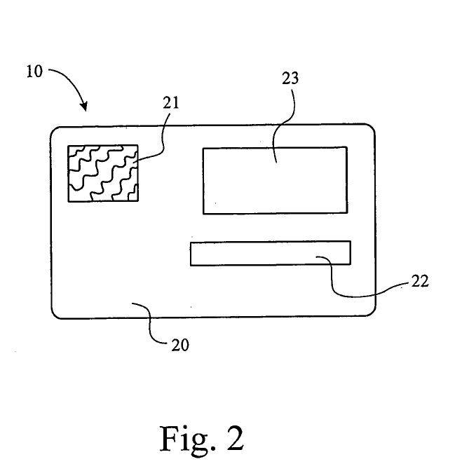

FIG. 2 illustrates a reverse side of a smart card;

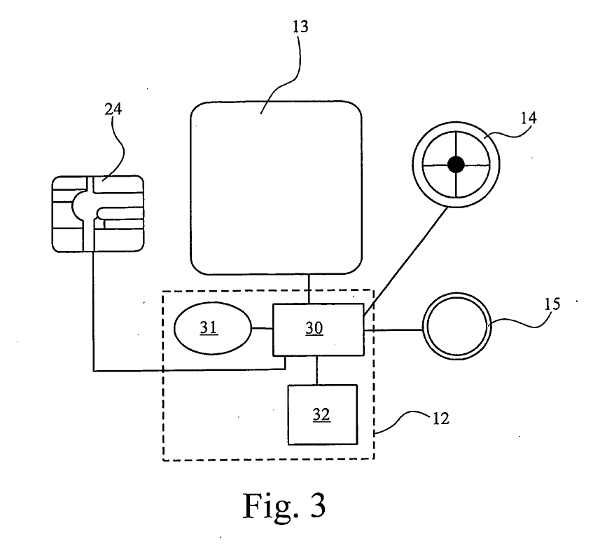

FIG. 3 illustrates component parts of a smart card;

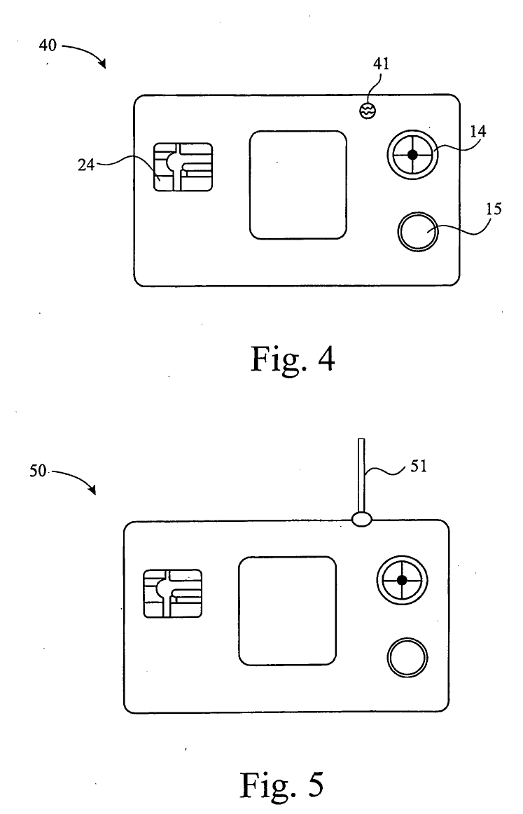

FIG. 4 illustrates a smart card including a visible alarm device;

FIG. 5 illustrates a smart card including a visible alarm device; and

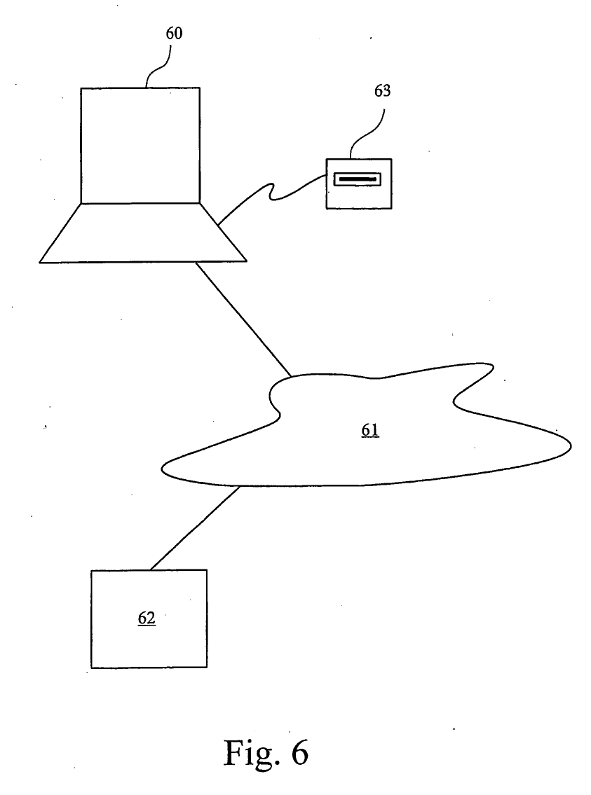

FIG. 6 illustrates how a smart card may be updated.

In the drawings like reference numerals refer to like parts.

FIG. 1 illustrates a smart card 10 in accordance with an embodiment of the present invention. The smart card includes a body portion 11 which is substantially credit card sized and manufactured from a similar resilient flexible plastic material. It will be understood that in accordance with further embodiments the body may be of different shapes and sizes and may be made from different materials. The smart card may be referred to as an “activity reminder smart card”, referred to by the acronym AR-SC. The AR-SC may be arranged to provide an acoustic alert and/or an electro magnetic alert in the visible spectrum. In the former instance the AR-SC may be referred to as an ARA-SC and in the latter case an AREM-SC. In both instances the smart card produces an alert cue either visibly and/or audibly which prompts a user hearing or seeing the alert to carry out an activity or to prepare for carrying out the activity. The smart card illustrated in FIG. 1 is an ARA-SC. It will be understood that embodiments of the present invention can include both an audible and visual warning device able to provide an audible and visible alert cue. Alternatively only an audible alert or a visible alert may be used.

The smart card 10 includes an integrated circuit 12 which is embedded within the card body 11. The integrated circuit includes a main microprocessor unit, clock and memory store. The smart card 10 also includes a power source 13 which is an ultra thin flat battery. The smart card also includes an audible alert device 14 which is a flat audio/alarm transducer. This can generate audible noise in the form of repeated tones or audible speech under control of the microprocessor 12 to provide an alert cue to a user that an activity should be performed. A function button 15 is also provided to enable a user to perform predetermined functions. This may either be simply turning off an alarm or selecting some other predetermined function such as telling the time of the next appointment or double clicking to provide a one hour snooze function.

Further user information such as a card issuer's name 16, a card holders name 17 valid dates for the card 18 and a card identity number 19 are displayed on the card.

FIG. 2 illustrates a reverse of the smart card 10. The back surface 20 includes a security hologram 21 which may be used to authenticate the card and a magnetic strip 22 formed from a thin magnetic element such as a strip which can be used to removably secure the card to a metallic surface such as a fridge door. In addition a region of the card 23 is set aside for further user information which may be printed material setting out key information such as telephone numbers and addresses of a service provider or some form of advertisement. Service providers providing such smart cards may then obtain advertising revenue or may advertise their own services. It will be understood that any of the features shown in FIG. 2 may be located on a front surface of the smart card 10 although it is highly preferable that the magnet is on the rear of the card so that a light or speaker on the front of the card are not obscured.

FIG. 1 illustrates a contact smart card which is programmed according to smart card standard technology for contact cards. A contact 24 is provided at an end region of the smart card 10 to enable data to be written to or read from the memory of the smart card. The contact 24 is provided to conform to a well known standard for contact smart cards such as ISO 7816. The contact 24 provides a programming interface for the card when it is located in a smart card reader.

FIG. 3 illustrates a schematic of the electrical connections between the main components illustrated in FIG. 1. The contact interface 24 is connected to a main microprocessor 30 which receives programming instructions when the card is programmed via smart card reader. A on-board real time clock 31 is provided to provide a running clock signal. An on-board integrated memory 32 is provided. The memory can be ROM, EEPROM and/or RAM. The main microprocessor, clock 31 and memory 32 are embedded in the card. The remaining components may be partially embedded and all parts are on board the smart card. Although the main microprocessor, clock and memory are shown as separate components in practice these components are likely to be integrated on a single chip 12. It will be understood that the on-board clock may be unnecessary as the main processors clock signal may be used to generate real time. Alternatively rather than programming the smart card with a specific time a number of time units may be indicated during a programming phase. Then only a counter is required on-board the smart card with an alarm queue being executed when the count is either reached or exhausted. The main microprocessor 30 is connected to a power source such as a flat battery 13 and to the audible speaker 14 and user button 15.

Use of non-volatile memory components enables flexible adaptation of new or multiple application programmes as well as minimising power consumptions. An appointment reminder protocol application programme as well as the appointment time data may be held in an EEPROM memory whilst the chip operating system is stored on ROM. In the embodiments shown in FIGS. 1 to 3 there is no digital to analogue components since the alert cue is a simple intermittent alarm beep which may be activated simply by applying a voltage to a speaker device. According to further embodiments of the present invention it is possible to use pulse width modulation techniques without requiring an expensive sound chip component to reproduce alarm calls that emit voice or musical information. Furthermore since the activity reminder smart card is an active device (i.e. the smart card has its own power source) then depending upon use an isolation circuit may be required for the card to work reliably with a standard smart card reader which normally works with a passive (i.e. no battery source in the smart card) smart card.

FIG. 4 shows another embodiment of an activity reminder smart card 40 which incorporates one or more electromagnetic wave emission source, 41. In this particular example, the source 41 is shown as at least one Light Emitting Diode (LED). The light will light up or flash to issue an alert to a user. This may be when the optional audio alarm is on, or it may function under other situations depending on the programme criteria. The LED(s) may be positioned anywhere on the card, although it is shown in FIG. 4 at an edge of the long side of the card for optimal visibility as the card may be carried in a handbag or wallet. The light covers or the actual LED light source may be of different colours to convey additional information or enable more utilities e.g. flashing red light indicates imminent hospital appointment, flashing blue light indicates imminent dentist appointment etc. One advantage of this additional feature is for providing extra awareness of the situation when the alarm is on, or to assist a person with hearing difficulties.

FIG. 5 shows another embodiment of the invention. A smart card 50 uses a visual alert. Instead of a visible LED light source on the surface of the card, the original light source, which may be a LED, is now embedded inside the card. The light is transmitted to outside the card via a strand of one or more flexible optical fibres, 51. The optical fibre 51 protrudes either vertically, as shown in FIG. 5 or horizontally out of one the edges of the card. The advantage here is that the light would be more easily spotted in some circumstances when a card may be stored in a limited visibility compartment inside a wallet or handbag.

Embodiments of the present invention make use of Smart Card technology i.e. provide an ARA-SC or AREM-SC that comply with the ISO 7816 standards for the physical characteristics and electrical interoperability, as well as the communication protocol between the IC card and the Card Acceptor Device (or more commonly known as a smart card reader). Note there are at least 25 existing and emerging standards that a smart card can adhere to. Most are based on, and/or are subset of the ISO 7816 standards such as the common EMV standard developed by the consortium of Europay International, MasterCard international and Visa International. Depending on the needs of the cardholders and issuers, embodiments of the present invention could of course comply with any one of these available standards. The AR-SC should be preferably constructed, as much as possible with common existing or emerging standards such that it allows it to be readily compatible with current or emerging smart card readers. It should be noted that there are also many smart card operating systems (e.g. ISO 7816-4, Java, MultOS, Windows), thus it is assumed that the AR-SC could be developed under any one of these operating systems, depending on the application and the card issuer's preference.

Embodiments of the present invention provide a smart card comprising a programmable integrated circuit microprocessor Smart Card with an onboard clock and memory integrated circuit that are linked to a flat speaker (e.g. a piezoelectric audio transducer) that can give out an audio alarm (i.e. ARA-SC). Depending on the specification of the components used in the invention, the audio alarm could be emitting voice or musical information or just some basic intermittent tone sound to alert the users. In addition to the audio alert, the invention may also, or instead incorporate an electromagnetic wave emission alert, such as a visual alert via the use of LEDs or protruding optical fibres. In this instance the smart card may be referred to as an ElectroMagnetic warning Activity Reminder Smart Card, or AREM-SC for short. As embodiments of the present invention are active devices, they need to be powered by an ultra-thin flat battery that would fit inside an ISO-standard smart card. Such batteries with sufficient capacity and specifications to work within the existing invention is now widely available via a number of high-technology battery producing companies such as Power Paper Ltd in Israel or Solicore Inc. in the USA, which produced the Flexion batteries. Preferably there is also a function button so the card user can deactivate the alarm when it is on, or press it to activate some other pre-programmed functions. The function button may be designed to prevent accidental activation e.g. a touch/pressure sensitive flat button or some switch that is embedded below the surface of the card. The AR-SCs may be issued to the service provider pre-programmed with the appropriate application software that controls the Appointment Reminder Protocol. The service provider (e.g. the doctor's receptionist) would simply issue such a card to the client who has an appointment, incorporating the essential appointment time data and indeed any other useful information (e.g. update clock/date) programmed to the client's card by the usual method of ‘swiping’ the AR-SC through a Smart card reader (note, it is generally understood that a Smart card reader can read as well as write data to a Smart card). The AR-SC would subsequently activate its appointment reminder alarm at predetermined times prior to the appointment, thus alerting the client of an imminent appointment with the service provider. The Smart card reader may be connected to a PC already used by the service provider who issues the appointment, or it could be bought as a standalone alone device that has its own keypads, so that appropriate information (e.g. appointment times) can be input into the machine, which could then output that information to the inserted AR-SC. Typically, such smart card reader is fully PC/SC compliant, and in some models also CT-API compliant. A desirable feature, depending on the needs of the issuers is that the smart card reader is also EMV certified.

Alternatively, according to further embodiments of the present invention information data may also be exchanged remotely, if the AR-SC is of contact-less type (e.g. complying with ISO 14443 or ISO 15693 standards). The inputted information such as the appointment time would thus inform the card to activate its appointment reminder alarm or message at predetermined times prior to the appointment in accordance with the appointment reminder protocol program that is stored inside the card. In this type of card an RF antenna is in built inside the card and is thus normally hidden from view. An example of a particularly effective and desirable appointment reminder protocol which can be used with a contact or contact-less smart card given later.

FIG. 6 illustrates how embodiments of the present invention will be readily re-usable as further or new additional appointments can be similarly programmed via a smart card reader or remotely if the card is of the contact-less type. Furthermore, as major service providers develop their electronic (appointment) booking programs, the most up to date booking information can be readily accessed and/or updated onto the client's AR-SC via the service provider's e-booking website. Firstly the client enters the service provider's e-booking website using a user terminal 60 such as a PC. The user logs on to the service providers website via the internet 61. The service provider 62 provides content for the website. The user then confirms their identity online (which may be via the AR-SC which may also contain authentication details, or via the traditional password method). Updated data is then written to the client AR-SC through a smart card reader 63 which is linked to the clients own personal computer 60. Note, many PCs can now be purchased with an integrated smart card reader, and it is expected that more new PCs will acquire this facility as standard in the future. The ability to update (download and upload) information online is especially useful as some appointments are rescheduled.

Embodiments of the present invention can be carried by the card holder along with his/her other credit size cards, acting as extra reminder to a paper appointment card, or that it can actually be attached in a non-permanent way (e.g. corners tucked securely behind slits in the paper appointment card or letter, or via a non-permanent adhesive tape or glue dot on the paper appointment card or letter) with the usual paper appointment card or letter. The advantage of the latter usage is that the AR-SC when it sounds its alarm may also act as an appointment card/letter locator, since research have shown that many paper appointment card/letter are frequently mislaid within the house, thus resulting in more frequent missed appointment. Another useful feature that may be incorporated in the design of the AR-SC is the attachment of a thin strip of weak magnet to the back of the card, so that the card may be readily affix to a metallic surface (e.g. on fridge or metal filing cabinet) in an area where it can be readily heard or seen when the reminding alert is activated.

One of the greatest advantages of incorporating smart card technology in accordance with embodiments of the present invention is the relative ease and flexibility to develop or change the bespoke application programs to suit the demand of individual organisations, and even the demands of individual clients. For example, in using the invention as-an appointment reminder device, the application software stored in the ARA-SC may utilise the following desirable Appointment Reminder Protocol, which has been designed with much consideration to the average user, in terms of effectiveness and minimising nuisance factor:

A first reminder alarm will sound at least 2 days before the actual appointment date, followed with a second reminder call alarm on the morning of the appointment date. The first reminder alarm is to enable the cardholder to offer sufficient warning time to the service provider in the event that the cardholder needs to alter the original appointment time. The first reminder alarm will always start only in the late afternoon, or early evening, so as not to be confused with the second reminder alarm which will start in the early morning on the date of the appointment.

The reminding alarms will be of a low intensity sound (e.g. beeps, chirps etc) repeated at a low intermittent frequency rate for a prolonged period (e.g. up to 30 minutes) or until it is turned off manually by pressing the function button 15. Compared to other alarm calling methods, this low intensity, low frequency and long reminding alarm duration protocol has the following advantages i) low power consumption ii) the long period of the alarm call ensures maximum effectiveness of the user hearing the alarm and iii) the low intensity and frequency of the reminding beeps prevent and minimises an annoyance condition to the card owner and other nearby people should the former not be able to immediately deactivate the alarm (e.g. whilst driving to work).

Additional utilities on the same reminder device can be realised by offering different reminding alarm sounds or via different frequency patterns of the alarm for different types of appointment (e.g. doctor, dental, hairdresser etc.), with printed instructions at the back of the card to inform the card owner of the meaning of the different sounds. Hence, potentially different departments or even totally different organisations can utilise the same card, provided a set of standard protocols are adhered to. To suit the needs of the particular service provider, the exact detail of the appointment reminder protocol can, of course, be readily changed by changing the program or the parameters within it.

The above described appointment reminder protocol assumes only a basic specification of the device, where the audio alarm is not capable of speech. If the device is capable of giving speech information, then more useful applications and alarm protocol can be written for the device. For example, the time and place of the next appointment(s) can be revealed verbally when the function button 15 is pressed at any time. Alternatively, pressing function button 15 at any time may activate a particular alarm sequence to indicate if there is any imminent activity (such as an appointment) within a particular set period.

A further embodiment of the present invention takes into account increasingly economic production developments whereby the above-mentioned embodiments can be made more powerful and flexible by including two additional advanced features built into the card. The new features are an electronic display, and one or more keypads to allow altering or updating existing information inside the card. For simple and efficient information updates, a minimum of two keypads can accomplish the task. The software may be written to allow one keypad to scroll through the list of option, and the other keypad to confirm the current selection or to return to the previous selection. The electronic display can show the relevant information about appointment time, and/or any other relevant information that would be useful to the operation of an activity reminder device. To fabricate an economically viable device with these new features using current mass market production technology, the thickness of the invention may need to increase by two or more times of the ISO dimension standard for smart cards. In this case, LCD or organic OLCD is a viable display option. Such card may require a specially designed smart card reader to accommodate the extra thickness of the card, or the card may be of the contact-less form, so that it can be programmed only remotely.

Below are described some other novel applications of the AR-SC, which can be realised by simply using a different application program or protocol. These applications include:
i) A medication reminder for a person that needs to take medicine regularly: i.e. a medication reminder protocol is written for the AR-SC such that it activates the alarm whenever the cardholder is required to take their medicine. Particular advantages of using the AR-SC are that changes in treatment regime, which necessitates changes in the medication reminder protocol, can be readily reprogrammed or updated through a smart card reader by the medical practitioner or the cardholder. A possible usage example would be for diabetic patients who need regular insulin injections.
ii) For current smart cards used for access authorisation or e-commerce transactions, modification of such cards to include the additional reminder functions of a AR-SC will allow the following additional useful functions a) Low credit limit or invalidation reminder: an alarm warning in the AR-SC credit card will activates when the credit limit sets by the cardholder or its issuer is reached, or for whatever reason, the card is no longer of valid use. The alarm would prompt a user to deposit money or transfer money into an associated account. Possible adaptations are bank or credit cards, and public transport payment smart cards. b) Car park time up reminder: Some car parks utilise smart card payment method. If such card incorporates the AR-SC features, then such card could provide a near time-up warning alert.
iii) ID cards worn by personnel could incorporate the AR-SC function, which gives the card an additional function of acting as a security action reminder. For example, a cardholder leaving a secure area may be required to perform some security related actions (e.g. set the alarm, lock the door). Through interaction with a contact-less version of the AR-SC/ID card, detectors near the entrance of the secure area will register when a cardholder is leaving the secure area. When the security related action is performed, a local wireless confirmation signal is sent to the contact-less version of the AR-SC. But if the card holder forgets to perform the security action within a programmed period of leaving the secure area, then due to the absence of not receiving the confirmation signal, the AR-SC/ID card, will then emit an audio and/or visible alarm to remind the cardholder that he/she has forgotten to perform the necessary security action e.g. lock the door. In addition, the card may also emit a wireless signal to a local receiver in the building to alert the relevant security personnel.
iv) Many sales letters, as used a in direct mail marketing program, especially those from a insurance related company, are now accompanied with information business-like cards in the form of a simple non-laminated plastic card, to remind the potential customer to ring the company when the customer's insurance (e.g. motorcar or household insurance) is due for renewal. The effectiveness of the sales letter can be substantially improved, if the simple advert card is upgraded to an information advert card with the AR-SC feature. Thus assuming the company knows the insurance renewal date of the customer, then the reminding alarm in the AR-SC could be set to activate near the insurance due date. This alert would thus remind the potential client to contact the company for a quote. Pressing the control button 15 would deactivate the alarm, or at any other time play a simple musical tune, so as to give the card some novelty value, thus increasing its retention value.
v) The AR-SC can be used by a detention authority to remind parole prisoners to carry out certain time sensitive duties e.g. to visit the parole officer at certain time.
vi) The contactless version of ARA-SC can replace current simple smart card key use in a hotel for accessing to the guest's room. The advantage of using such ARA-SC key is that if the guest accidentally leaves the hotel entrance with the key, such key may then be triggered to activate its alarm to remind guest to hand in key with the hotelier. The triggering may be when a predetermined time elapses, or when a user carries the smart card past a predetermined location.

Although, the current ARA-SC has many distinct features compared to the authentication type acoustic smart card, the manufacturing techniques of both types may be similar (see for example patent no. WO0139113 for the fabrication details of an authentication card incorporating a piezoelectric element).

The advantages of using the smart card according to embodiments of the present invention for incorporating an appointment reminder application are its compactness, reusability, easily programmable with time sensitive data and control programs, familiarity and relevance to existing smart card applications, and convenience of building on existing smart card technology and standards, thus reducing the commercial and psychological burden of developing new infrastructure. The present invention is therefore compact, relatively inexpensive, and potentially multi-functional and can be adopted and issued to clients by many types of service provider e.g. hospital departments, various healthcare providers such as dentist and GP surgeries, private businesses that regularly allocate appointments or events.

The above-mentioned embodiments have been described by way of example only. It would be understood that modifications may be made to the specifics of these examples without departing from the scope of the present invention.

1.-35. (canceled)

36. Apparatus for reminding a user of an activity to be performed, comprising:
a Smart Card comprising:
a card body;
an integrated circuit microprocessor;
a power source; and
a least one user alert device for alerting a user at a predetermined time prior to performance of said activity.

37. The apparatus as claimed in claim 36, wherein said Smart Card is a contact Smart Card conforming to ISO 7816 Standards.

38. The apparatus as claimed in claim 36, wherein said Smart Card is a contact-less Smart Card conforming to ISO 14443 or ISO 15693 Standards.

39. The apparatus as claimed in claim 36, wherein said Smart Card further comprises:
a user button for enabling a user to select a desired function of said Smart Card.

40. The apparatus as claimed in claim 36, wherein said Smart Card is reprogrammable.

41. The apparatus as claimed in claim 36, wherein said at least one user alert device comprises a flat speaker for providing an audio alarm.

42. The apparatus as claimed in claim 41, wherein said speaker comprises a piezoelectric audio transducer.

43. The apparatus as claimed in claim 36, wherein said at least one user alert device comprises a visual alert for providing a visual cue to a user.

44. The apparatus as claimed in claim 43, wherein said visual alert comprises at least one light emitting diode (LED).

45. The apparatus as claimed in claim 43, wherein said visual alert comprises at least one optical fiber strand protruding from said card and a light generating member for generating and transmitting light down said at least one optical fiber strand.

46. The apparatus as claimed in claim 36, wherein said power source comprises an ultra-thin flat battery.

47. The apparatus as claimed in claim 36, wherein said Smart Card further comprises a display area for displaying user information.

48. The apparatus as claimed in claim 36, wherein said Smart Card further comprises an on-board clock for keeping a running time.

49. The apparatus as claimed in claim 36, wherein said Smart Card comprises a magnetic element for enabling a user to removably secure said Smart Card to a metallic surface.

50. The apparatus as claimed in claim 36, wherein said card body comprises a credit card size plastic card.

51. The apparatus as claimed in claim 36, further comprising:
a Smart Card reader for programming said Smart Card with information relating to said activity.

52. The apparatus as claimed in claim 51, wherein said Smart Card reader is a contact Smart Card reader compatible with ISO 7816 Standards.

53. The apparatus as claimed in claim 51, wherein said Smart Card reader is a contact Smart Card reader conforming to PC/SC and/or CT-API and/or EMV certified ISO Standard.

54. The apparatus as claimed in claim 51, wherein said Smart Card reader is a contact-less Smart Card reader compatible with ISO 14443 or ISO 15693 Standards.

55. The apparatus as claimed in claim 53, wherein said Smart Card reader is connectable to a personal computer (PC).

56. The apparatus as claimed in claim 36, wherein said activity comprises an appointment to be met or a medication to be taken or a deposit of money at a bank to be made or that a door should be locked or that a further security action such as setting an entrance alarm should be carried out.

57. A method for reminding a user to perform a predetermined activity, comprising the steps of:
providing a Smart Card comprising at least one user alert device for providing an alert cue to a user at a predetermined time prior to performance of said activity;
programming said Smart Card via a Smart Card reader;
providing said programmed Smart Card to said user; and
at said predetermined time generating an alert cue via said Smart Card.

58. The method as claimed in claim 57, wherein said step of programming comprises:
locating said Smart Card in a contact Smart Card reader conforming to ISO 7816 Standards and storing user information associated with said predetermined activity in said Smart Card.

59. The method as claimed in claim 57, wherein said step of programming comprises:
locating said Smart Card in a contact-less Smart Card reader conforming to ISO 14443 or ISO 15693 Standards, and storing user information associated with said predetermined activity in said Smart Card.

60. The method as claimed in claim 22, wherein said step of providing said programmed Smart Card comprises posting said Smart Card to said user prior to said predetermined time.

61. The method as claimed in claim 60, further comprising the step of securing said Smart Card to a letter sent from a service provider.

62. The method as claimed in claim 61, further comprising removably securing said Smart Card to said letter.

63. The method as claimed in claim 57, wherein said step of providing comprises handing said Smart Card to said user at an appointment with a service provider prior to said predetermined time.

64. The method as claimed in claim 22, further comprising the steps of:
subsequent to said step of generating an alert cue, via a user button of said Smart Card, a user selecting a function of said Smart Card.

65. The method as claimed in claim 22, further comprising the steps of:
generating an alert cue at a further predetermined time prior to said predetermined time for providing a reminder identifying said predetermined time.

66. The method as claimed in claim 57, wherein said step of generating an alert cue comprises, via an on-board speaker, generating audible speech information.

67. The method as claimed in claim 57, further comprising updating information stored on said Smart Card via a web page.

68. The method as claimed in claim 57, further comprising reminding said user according to an appointment reminder protocol.
